(19) United States
(12) Patent Application Publication
(10) Pub. No.: US 2024/0200605 A1
(43) Pub. Date: Jun. 20, 2024

(54) SEAL ASSEMBLY AND ROLLING BEARING COMPRISING SUCH AN ASSEMBLY

(71) Applicant: HUTCHINSON, PARIS (FR)

(72) Inventors: Jean LOR, LeBourg d'lré (FR); Patrick BRUN, Chateau Gontier (FR); Clément ROBIN, Presnoy (FR); Eliette Hélène Céline PINEL, Marges (FR)

(73) Assignee: HUTCHINSON, PARIS (FR)

(21) Appl. No.: 18/283,397

(22) PCT Filed: Mar. 23, 2021
(86) PCT No.: PCT/FR2021/050498

§ 371 Date: Sep. 21, 2023

(51) Int. Cl. F16C 33/78; F16C 19/18

(52) U.S. Cl. CPC F16C 33/7823; F16C 19/183; F16C 2326/02

(57) ABSTRACT

Seal assembly comprising a fixed element, a rotatable element, and a sealing member. A first lip comprises an annular smooth region at the end of the first lip. The first lip and a second lip each comprise an irregular region on the face oriented towards the sliding surface. The assembly comprises a grease which is a grease having a degree of bleeding that is greater than or equal to 5 percent.

### TECHNICAL FIELD

This invention relates to seal assemblies.

### PRIOR ART

More particularly, the invention relates to a seal assembly comprising:
a fixed element,
a rotatable element intended to be rotatable relative to the fixed element about an axis of rotation (X), and
a sealing member comprising a rigid annular frame integrally mounted on one among the fixed element and the rotatable element, and a seal made of an elastic material and in contact with a sliding surface of the other element among the fixed element and the rotatable element,
the seal comprising a first lip and a second lip which both extend from the annular frame towards the sliding surface,
the first lip and the second lip and the sliding surface defining an internal volume at least partially filled with a grease.

Examples of assemblies of this type are known.

Such a seal assembly is for example used in a bearing, and for example in an automobile wheel bearing. This seal assembly makes it possible in particular to contain a lubricating fluid inside the bearing in order to ensure that the bearing operates with low friction.

Unfortunately, this seal assembly contributes to increasing the friction, i.e. the rotational friction torque. This phenomenon is part of the mechanical energy losses during rotation. To reduce these losses, low-friction solutions which allow maintaining a seal are being sought.

Patent EP 2687761 describes an example of such a seal assembly in which the lips have concavities and convexities that are between 1.0 and 3.0 μm Ra, and in which a low viscosity grease is used, said grease having a base oil with a kinematic viscosity of between 10 and 40 mm²/s at 40° C.

### DISCLOSURE OF THE INVENTION

The present invention relates to a seal assembly of this type, and in particular that is improved in order to reduce friction torque while maintaining excellent sealing.

To this end, the seal assembly is characterized in that
the first lip comprises a annular smooth region at the end of the first lip and on a face oriented towards the sliding surface, said smooth region being suitable for ensuring continuous contact with the sliding surface along the entire circumference of the first lip around the axis of rotation,
the first lip and the second lip each comprise an irregular region on the face oriented towards the sliding surface, and
the grease is a grease having a degree of bleeding that is greater than or equal to 5 percent.

Due to these arrangements, firstly a very good sealing by the seal assembly is ensured, and in particular an excellent static sealing which prevents any leakage of lubricant between the interior and the exterior of a device, and an excellent dynamic sealing during rotation of the rotatable element relative to the fixed element.

Secondly, a reduced friction torque is ensured in comparison to the solutions of the prior art. The high-bleeding grease contained in the volume between the first lip and the second lip ensures frictionless sliding of said lips on the sliding surface. In particular, the irregular region has extremely reduced friction on the sliding surface.

This combination of technical characteristics allows reducing the friction torque with no loss of sealing in the seal assembly, which is essential for this type of seal assembly device.

In various embodiments of the seal assembly, one or more of the following arrangements may possibly also be used:

According to one aspect, the grease has a degree of bleeding that is greater than or equal to 6 percent.

According to one aspect, the grease comprises a base oil having a kinematic viscosity of between 7 mm²/s and 20 mm²/s at a temperature of 40° C.

According to one aspect, the irregular region has an arithmetic average roughness of between 3.5 and 5 μm.

According to one aspect, the first lip and/or the second lip has a flexibility suitable for exerting a pressure on the sliding surface of between 0.1 and 2 MPa, the sealing member being mounted on said sliding surface.

According to one aspect, the annular smooth region has a width of between 0.05 mm and 0.2 mm.

According to one aspect, the irregular region is obtained by laser machining or by spark erosion of a corresponding surface of a mold used to produce the sealing member.

According to one aspect, the first lip extends axially from the annular frame towards the sliding surface, and the second lip extends axially from the annular frame towards the sliding surface.

According to one aspect, the assembly further comprises an annular ring, integral with the other element, the sliding surface being formed on said annular ring.

The invention also relates to a rolling bearing comprising a seal assembly according to the above characteristics and rolling bodies arranged in a bearing space in order to allow the relative rotation of the rotatable element with respect to the fixed element, about the axis of rotation.

### BRIEF DESCRIPTION OF THE DRAWINGS

Other features and advantages of the invention will become apparent from the following description of one of its embodiments, given as a non-limiting example, with reference to the appended drawings.

In the drawings:

FIG. 1 is a cross-section of a seal assembly according to a first embodiment of this disclosure;

FIG. 1A is an enlarged view of part of FIG. 1;

FIG. 2 is a cross-section of a seal assembly according to a second embodiment of this disclosure;

FIG. 3 is a rolling bearing comprising a seal assembly according to FIG. 1 or FIG. 2;

FIG. 4a is a photograph showing a sealing lip of a seal assembly according to FIG. 1 or FIG. 2;

FIG. 4b is the profile of the lip of FIG. 4a; and

FIG. 5 is a graph representing the friction torque as a function of the interference distance for a seal assembly according to the prior art and according to this disclosure.

In the various figures, the same reference numerals designate identical or similar elements.

### DETAILED DESCRIPTION

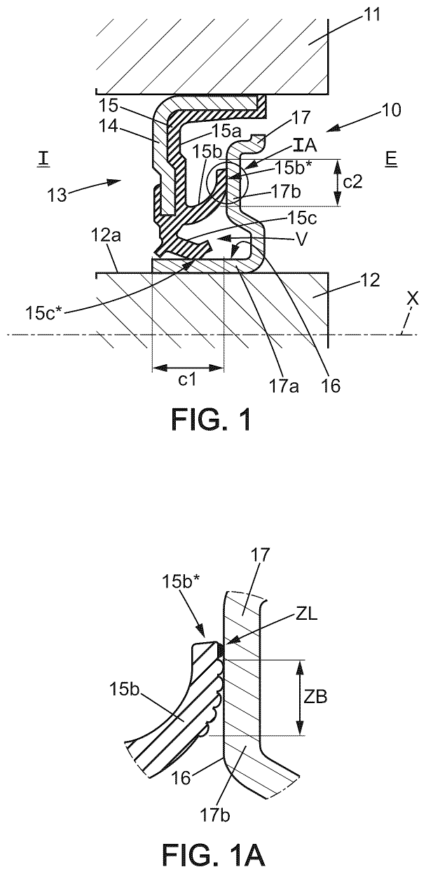

FIG. 1 shows a first embodiment of a seal assembly 10 which comprises:
a fixed element 11,
a rotatable element 12 that is rotatable relative to the fixed element about an axis of rotation X, and
a sealing member 13 comprising a rigid annular frame 14 and a seal 15 integral to the frame, said seal 15 being made of an elastic material and being in sliding contact with a sliding surface 16.

In particular, fixed element 11 can be an external element, i.e. the farthest from axis of rotation X, i.e. located around rotatable element 12 which is then an internal element. This is the case when using a rotatable element 12 which is a rotating shaft (FIG. 1).

Conversely, fixed element 11 can be an internal element, i.e. the closest to axis of rotation X, i.e. located inside the rotatable element which is then an external element.

To simplify this description, we will consider frame 14 to be connected to external fixed element 11, and sliding surface 16 to be connected to the other element, i.e. internal rotatable element 12, but of course the other use is also suitable for the seal assembly of this disclosure.

Seal 15 comprises:
an attachment portion 15a which is fixed to at least one surface of frame 14, for example by overmolding onto said frame 14, and advantageously with an adhesive having previously been coated on said surface of the frame, and
a first lip 15b which extends for example axially from annular frame 14 to sliding surface 16 so as to be in contact with a first portion of sliding surface 16 at one lip end 15b*, and
a second lip 15c which extends for example radially from annular frame 14 to sliding surface 16 so as to be in contact at one lip end 15c* with a second portion of sliding surface 16.

First lip 15b, second lip 15c, and sliding surface 16 form a closed and sealed annular cavity, of volume V, into which a grease G can be introduced at the time when seal assembly 10 is manufactured or at the time when it is mounted in a device.

In the embodiment of FIG. 1, sliding surface 16 is formed on an annular ring 17 that is integral with the other element (rotatable element 12). This ring is for example a metal piece. It is located between rotatable element 12 and seal 15. Lip end 15b* of seal 15 is in sliding contact with a surface of this ring which rotates with rotatable element 12.

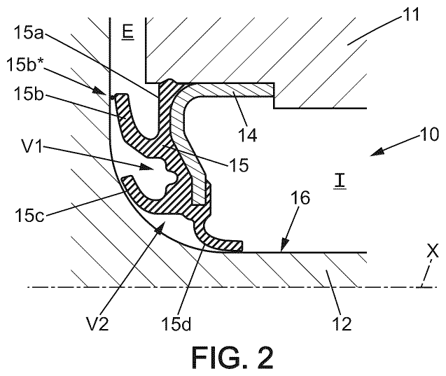

In the embodiment of FIG. 2, sliding surface 16 is an integral part of rotatable element 12, in particular of external cylindrical surface 12a of rotatable element 12. Sliding surface 16 corresponds to an annular portion of cylindrical surface 12a. Sliding surface portion 16 is positioned in correspondence to sealing member 13 (in the longitudinal position) so that lip end 15b* of seal 15 is in contact with sliding surface 16.

As shown in FIG. 2, seal 15 may comprise more than two sealing lips. In FIG. 2 it comprises two, but seal 15 may comprise two, three, four, or more sealing lips. Thus, in FIG. 2, first lip 15b, second lip 15c, and sliding surface 16 form a first closed and sealed annular cavity of volume V1. Second lip 15c, third lip 15d, and sliding surface 16 form a second closed and sealed annular cavity of volume V2. Each of said annular cavities (V, V2) can contain said grease, introduced at the time when seal assembly 10 is manufactured or at the time when it is mounted in a device.

Returning to the first embodiment in FIG. 1, annular ring 17 is integral with rotatable element 12. It is located between rotatable element 12 and seal 15. Lip end 15b* of seal 15 is in sliding contact with at least one surface of this ring 17 which rotates with rotatable element 12.

In this first embodiment, annular ring 17 comprises more specifically:
a cylinder portion 17a mounted to be integral with rotatable element 12, for example by fitting tightly onto cylindrical surface 12a of said rotatable element 12, and
a flange portion 17b which extends radially relative to axis of rotation X, from one end of said cylinder portion 17a.

Seal 15 then comprises a first lip 15b which extends axially from annular frame 14 to flange portion 17b, and a second lip 15c which extends axially from annular frame 14 to cylinder portion 17a.

Sliding surface 16 here is therefore an integral part of annular ring 17, fixed to rotatable element 12. Sliding surface 16 corresponds for example to all or part of an outer surface of annular ring 17 that is directed towards frame 14.

Sliding surface 16 comprises for example:
a first part on cylinder portion 17a of annular ring 17, said first part extending along a length c1 in the longitudinal direction of axis of rotation X and in correspondence to (facing) second lip 15c, and
a second part on flange portion 17b of annular ring 17, said second part extending along a length c2 in a direction substantially perpendicular to the longitudinal direction of axis of rotation X and in correspondence to (facing) second lip 15c.

Thus, ends 15b*, 15c* of first lip 15b and of second lip 15c are in sliding contact with sliding surface 16.

In FIGS. 1 and 2, the reference I corresponds to the inner side of the product which will be sealed off by seal assembly 10; this inner side is able to contain an oil or grease that is to be stored. The reference E corresponds to the external side of the product, i.e. the outside environment which also can be attacked by fluids and/or dust against which the seal assembly also offers protection.

According to this disclosure, seal assembly 10 further comprises the following features:
first lip 15b comprises a annular smooth region ZL at end 15b* of first lip 15b and on a face of first lip 15b oriented towards the sliding surface, said smooth region ZL being suitable for ensuring continuous contact with said surface sliding 16 along the entire circumference of first lip 15b around axis of rotation X,
first lip 15b and second lip 15c each comprise an irregular region ZB on said face oriented towards the sliding surface, and
grease G is a grease having a degree of bleeding that is greater than or equal to 5 percent.

FIG. 1A is an enlarged view of first lip 15b of FIG. 1, schematically representing the face of first lip 15b oriented towards sliding surface 16, and comprising, starting from end 15b* of first lip, smooth region ZL then irregular region ZB.

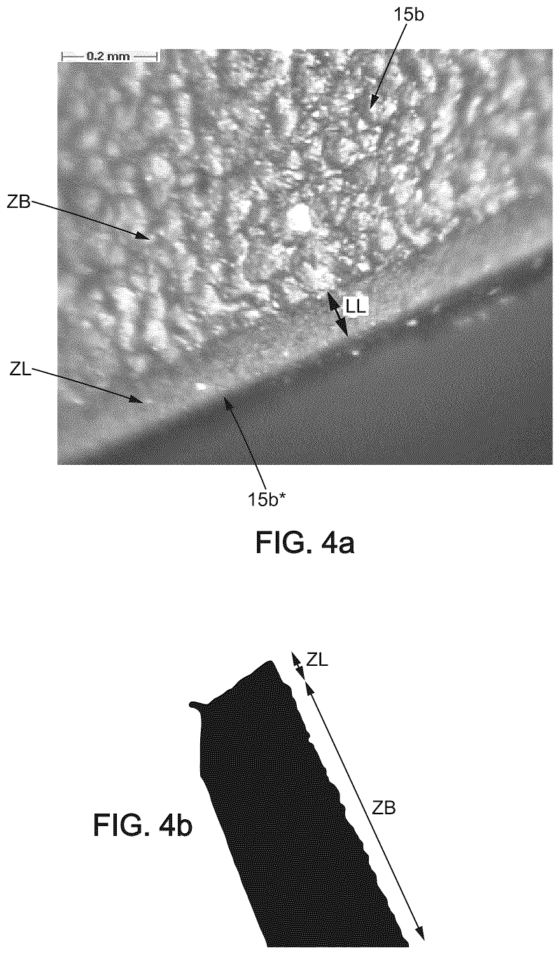

FIG. 4a shows a photograph of enlarged end 15b* of the face of first lip 15b oriented towards sliding surface 16. The very dark lower part of this photograph corresponds to empty space; first lip 15b is in the upper part of this photograph with the reliefs in various shades of gray.

FIG. 4b shows the profile of the lip of FIG. 4b. This profile corresponds to a section view of the lip in a plane extending radially relative to the axis of rotation.

One will observe, in the photograph of FIG. 4a, smooth region ZL which is a continuous strip at end 15b* of first lip 15b and which extends along the entire circumference of first lip 15b. Smooth region ZL can also be referred to as “bump-free”. Smooth region ZL therefore ensures continuous contact along the entire circumference of first lip 15b. First lip 15b thus has good sealing, and grease or any fluid enclosed within the annular cavity remains in this cavity during a static position or during dynamic operation (rotation of rotating element 12).

Smooth or bump-free region ZL has a smooth width LL of between 0.05 mm and 0.2 mm. For example, the smooth width is between 0.1 mm and 0.2 mm.

Optionally, second lip 15c or any other lip of seal 13 can comprise such a smooth or bump-free region.

Optionally, first lip 15b or any other lip can comprise several smooth regions of this type.

In this photograph, one can also see irregular region ZB of the face oriented towards the sliding surface. Irregular region ZB is a region which comprises a multitude of bumps which have, for example, irregular shapes. These bumps are for example protrusions that extend outwards from the lip and have a convex shape, i.e. the opposite of a recess. These bumps may also be semi-spherical protuberances of variable diameter. Irregular region ZB can also be referred to as “stippling” in technical terms.

Irregular region ZB has for example an arithmetic average roughness Ra of between 3.5 and 5 μm.

Irregular region ZB extends over the face oriented towards the sliding surface, for an irregular region width which can depend on the size of the lip, and for example comprised between 1 mm and 2 mm, or between 1 mm and 4 mm. This irregular region width can in particular be suitable for covering any area of contact between the lip and sliding surface 16 when in its mounted position.

Irregular region ZB is for example obtained by laser machining or by spark erosion of a corresponding surface of a mold suitable for producing/forming sealing member 13. The shape of this corresponding surface of the mold is a negative space that has the shape of the face of the lip oriented towards the sliding surface.

Thus, there is extra thickness in irregular region ZB on the face of the lip intended to be oriented towards the sliding surface. In other words, the corresponding surface of the mold corresponding to irregular region ZB is a recessed or negative-space surface. Conversely, smooth region ZL is set back relative to the face of the lip intended to be oriented towards the sliding surface, i.e. set back relative to an external line placed on the irregular region within the section plane of its profile.

Other processes for producing the corresponding surface of the mold are possible: 3D printing of the mold or a portion of the mold, addition of an insert into the mold, etc.

The lips of seal 13 are curved in the mounted position as shown in FIGS. 1 and 2, which ensures contact between the ends of these lips (15b, 15c, 15d) and sliding surface 16. Due to this curvature of the lips, smooth region ZL and irregular region ZB are in contact with sliding surface 16. Irregular region ZB traps an amount of grease in the voids between the bumps or protrusions, and sliding surface 16. This ensures that sliding occurs with a lower friction torque than in the seal assemblies of the prior art.

In addition, the curvature of a sealing lip on a sliding surface corresponds to an interference distance Di. Interference distance Di is zero for a simple contact on the sliding surface, i.e. with no curvature of the lip. Interference distance Di increases the more the lip is squashed towards the sliding surface, i.e. the greater the curvature of said lip.

First lip 15b and/or second lip 15c has a flexibility suitable for exerting pressure on sliding surface 16 that is comprised between 0.1 and 2 MPa, in the mounted position on the product, i.e. for a nominal interference distance defined for the mounting of seal assembly 10.

A grease is primarily composed of a base oil containing a thickener, and additives to reinforce the properties of the grease. Grease consistency depends on the type and concentration of the thickener, and on the operating temperature.

Bleeding of a grease is its tendency to separate from the base oil under predetermined conditions, and more particularly at rest. For example, in the method of standard IP 121/75, an amount of grease is placed in a container having a bottom screen in the form of a cone of type 240 (61 μm mesh); the mass of base oil separated from the grease by the action of a load exceeding 100 g is measured, at a temperature of 40° C. and for a duration of 42 hours or 168 hours.

The degree of bleeding is then the ratio of the mass of separated base oil to the mass of grease initially placed in the container; this ratio can therefore be expressed as a percentage.

Other bleed measurement standards exist, with different procedures. For example, in the method of the ASTM D1742 standard, an amount of grease is placed in a container with a bottom 75 μm mesh or sieve; the mass of base oil separated from the grease under pressurized air exceeding 1.72 kPa is measured, at a temperature of 25° C. and for a duration of 24 hours. Those skilled in the art will be able to establish equivalences between these standards on the basis of their experience.

Grease G used in seal assembly 10 according to the present disclosure is a high-bleeding grease. “High bleeding” is understood to mean a much higher level of bleeding than the greases generally used between the lips of a seal assembly according to the prior art. In fact, it is usually desired to have a low bleeding value for such greases in order to avoid any deterioration in the properties of the grease over time, during static and dynamic operation of the seal assembly.

More particularly, grease G is for example a grease having a degree of bleeding that is greater than or equal to 5 percent, according to the IP 121/75 standard cited above. By virtue of this degree of bleeding, grease G of seal assembly 10 separates from a suitable amount of base oil during its dynamic rotational operation, this oil being able to flow towards irregular region ZB so as to reduce the friction torque of seal 15 on sliding surface 16.

Tests will allow, for example, adapting the properties of grease G, and for example its degree of bleeding, to the characteristics (shapes) of irregular region ZB, and also to the technical specifications for the product and for seal assembly 10.

In some cases, it is desirable for example to have a grease G with a degree of bleeding that is greater than or equal to 6 percent, or even 8 percent. The friction torque of seal 15 on sliding surface 16 is then reduced.

To obtain such a high degree of bleeding, which is not usual in dynamic seal assembly applications, in particular for bearings, grease G has for example a base oil of low kinematic viscosity. Indeed, the lower this kinematic viscosity, the higher the degree of bleeding. In addition, grease G comprises a thickener, also referred to as “grease soap”, having a high consistency. The higher this consistency, the higher the degree of bleeding.

For example, the base oil used in grease G has a kinematic viscosity of between 7 mm²/s and 20 mm²/s at a temperature of 40° C.

This choice of grease G having a high degree of bleeding is the opposite of the usual choice in the mechanical field. This choice allows it to be more suitable for the low contact pressure from lips 15b, 15c of seal assembly 10. This makes it possible to reduce the friction torque.

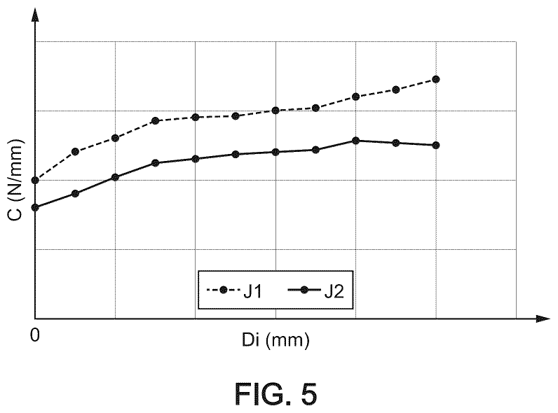

FIG. 5 illustrates some curves of friction torque C as a function of interference distance Di, for:
a first seal assembly J1 according to the prior art, i.e. with no smooth region ZL, no irregular region ZB, and no high-bleeding grease G; and
a second seal assembly J2 according to this disclosure, i.e. with the technical characteristics mentioned above.

The friction torque of the second seal assembly J2 is much lower than that of the first seal assembly J1.

The friction torque of the second seal assembly J2 increases less with interference distance Di than in the first seal assembly J1, which means that the second seal assembly makes it possible to offer a lower friction torque and more robustness against a variation in interference distance Di.

Seal assembly 10 according to the invention is thus greatly improved over the prior art. This seal assembly makes it possible to obtain a lower friction torque while maintaining the same sealing performance.

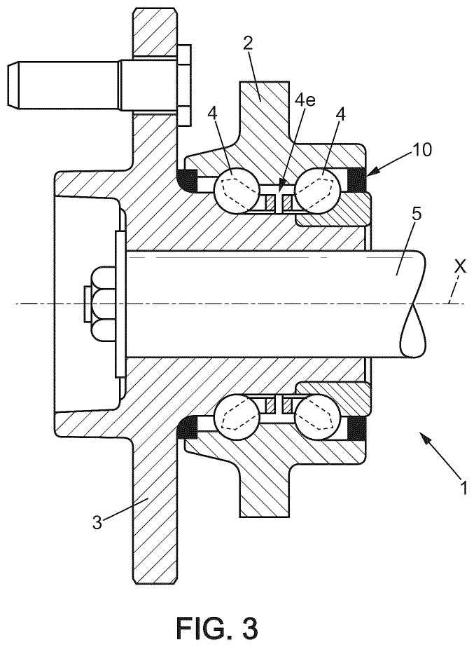

FIG. 3 shows a rolling bearing 1 comprising a seal assembly 10 as described above, on at least one side, in order to seal off an inner space of said rolling bearing. The rolling bearing is for example a rolling bearing of a motor vehicle, and more particularly for example a rolling bearing of a motor vehicle wheel, as shown in FIG. 5.

Rolling bearing 1 comprises in particular:
a fixed member 2,
a rotatable member 3 rotated by a shaft 5 and on which is fixed for example a vehicle wheel, and
rolling bodies 4 arranged in the bearing space 4e formed between fixed member 2 and rotatable member 3 so as to allow the relative rotation of rotatable member 3 with respect to fixed member 2 about axis of rotation X, while absorbing significant forces between the fixed member and the rotatable member.

Fixed element 11 of seal assembly 10 is either fixed member 2 directly, or is fixed to fixed member 2 of rolling bearing 1.

Rotatable element 12 of seal assembly 10 is either rotatable member 3 directly, or is fixed to rotatable member 3 of rolling bearing 1.

Rolling bodies 4 can be balls or rollers or any other known type.

By means of seal assembly 10 according to this disclosure, rolling bearing 1 has a lower friction torque than the prior art. A vehicle equipped with such devices will therefore consume less energy in moving forward.

1. A seal assembly comprising:
a fixed element
a rotatable element intended to be rotatable relative to the fixed element about an axis of rotation, and
a sealing member comprising a rigid annular frame integrally mounted on one among the fixed element and the rotatable element, and a seal made of an elastic material and in contact with a sliding surface of the other element among the fixed element and the rotatable element,
the seal comprising a first lip and a second lip which both extend from the annular frame towards the sliding surface,
the first lip and the second lip and the sliding surface defining an internal volume at least partially filled with a grease,
the seal assembly being characterized in that
the first lip comprises a annular smooth region at the end of the first lip and on a face oriented towards the sliding surface, said smooth region being suitable for ensuring continuous contact with the sliding surface along the entire circumference of the first lip around the axis of rotation,
the first lip and the second lip each comprise an irregular region on the face oriented towards the sliding surface, and
the grease is a grease having a degree of bleeding that is greater than or equal to 5 percent.

2. The assembly according to claim 1, wherein the grease has a degree of bleeding that is greater than or equal to 6 percent.

3. The assembly according to claim 1, wherein the grease comprises a base oil having a kinematic viscosity of between 7 mm²/s and 20 mm²/s at a temperature of 40° C.

4. The assembly according to claim 1, wherein the irregular region has an arithmetic average roughness of between 3.5 and 5 μm.

5. The assembly according to claim 1, wherein the first lip and/or the second lip has a flexibility suitable for exerting a pressure on the sliding surface of between 0.1 and 2 MPa, the sealing member being mounted on said sliding surface.

6. The assembly according to claim 1, wherein the annular smooth region has a width of between 0.05 mm and 0.2 mm.

7. The assembly according to claim 1, wherein the irregular region is obtained by laser machining or by spark erosion of a corresponding surface of a mold used to produce the sealing member.

8. The assembly according to claim 1, wherein the first lip extends axially from the annular frame towards the sliding surface, and the second lip extends axially from the annular frame towards the sliding surface.

9. The assembly according claim 1, further comprising an annular ring, integral with the other element, the sliding surface being formed on said annular ring.

10. A rolling bearing comprising a seal assembly according to claim 1, and rolling bodies arranged in a bearing space in order to allow the relative rotation of the rotatable element with respect to the fixed element, about the axis of rotation.
